(19) United States
(12) Patent Application Publication
(10) Pub. No.: US 2013/0311075 A1
(43) Pub. Date: Nov. 21, 2013

(54) MOTORCYCLE AND HELMET PROVIDING ADVANCE DRIVER ASSISTANCE

(71) Applicant: Continental Automotive Systems, Inc., Auburn Hills, MI (US)

(72) Inventors: Vinh H Tran, Farmington Hills, MI (US); David Muscat, Lake Orion, MI (US); Juan Rivera Cruz, Tlajomulco de Zuniga (MX); Antonio Moya Carrillo, Tlaquepaque (MX); Diego Alejandro Alvarez Alonso, Guadalajara (MX); Enrique Chavez, Tlaquepaque (MX)

(73) Assignee: Continental Automotive Systems, Inc., Auburn Hills, MI (US)

(21) Appl. No.: 13/897,570

(22) Filed: May 20, 2013

Related U.S. Application Data
(60) Provisional application No. 61/648,690, filed on May 18, 2012.

(51) Int. Cl. G08G 1/16

(52) U.S. Cl. CPC G08G 1/166
USPC 701/117

(57) ABSTRACT

A safety system for motorcycle comprises at least one sensor mounted to the motorcycle to sense a feature of an environment surrounding the vehicle. An electronic control unit is configured to receive a signal from the at least one sensor and determine a probability that a safety incident may occur based upon the at least one feature. The probability is compared to at least a first threshold and the electronic control unit is configured to send at least one indicator signal when the at least one feature is above the first threshold. The indicator signal may be displayed on a helmet display. The safety system may be one of blind spot detection, forward collision alert, rear collision alert, cross-traffic alert, merging-traffic alert, lane departure warning, and traffic sign recognition.

### PRIORITY CLAIM

This application is a non-provisional of, and claims priority to the May 18, 2012, filing date of, U.S. provisional patent application Ser. No. 61/648,690, the entire content of which is incorporated herein by reference.

### TECHNICAL FIELD

The present disclosure relates to motorcycles and more particularly to driver assistance systems for motorcycles.

### BACKGROUND

Motorcycles have increased safety concerns than operators of automotive vehicles. Additionally, due to the open area in which operators are positioned when operating the motor cycle and the two-wheel nature of the motorcycle the availability of standard safety systems, such as airbags, is reduced.

Therefore, motorcycle operators must be careful to avoid traffic incidents. Specifically, motorcycle operators must be careful to see the surrounding vehicle and that the motorcycle is seen by operators of the surrounding vehicles. One such instance in particular occurs when at a stop the single rear brake light of a motorcycle can be confused with one of the brake lights of a vehicle located in front of the motorcycle.

### SUMMARY

A method of improving safety for a motorcycle comprising sensing at least one feature of an environment surrounding the motorcycle with at least one sensor mounted to the motorcycle. An electronic control unit for the safety system determines a probability that a safety incident may occur based upon the at least one feature and compares the probability to at least a first threshold. An indicator is provided that is capable of being sensed by an operator of the motorcycle and/or a person in proximity to the motorcycle when the at least one feature meets the first threshold.

A safety system for motorcycle comprises at least one sensor mounted to the motorcycle to sense at least one feature of an environment surrounding the vehicle. An electronic control unit is connectable to at least one motorcycle system, wherein the electronic control unit is configured to receive a signal from the at least one sensor and determine a probability that a safety incident may occur based upon the at least one feature and compare the probability to at least a first threshold. The electronic control unit is configured to send at least one indicator signal when the at least one feature is above the first threshold.

A method of improving safety for a motorcycle comprises sensing at least one of a feature of a vehicle proximate to the motorcycle with at least one sensor mounted to the motorcycle. An electronic control unit for the safety system determines a probability that the vehicle is preparing to perform one of crossing the path of the motorcycle and moving into the path of the motorcycle. The probability is compared to a threshold and an indicator is provided when the probability is greater than the threshold. The indicator is capable of being sensed by an operator of the motorcycle and/or a person in proximity to the motorcycle.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic side view illustration of a motorcycle having safety system of the present invention;

FIG. 2 is a schematic top view illustration of the motorcycle and an exemplary surrounding environment for using the safety system of FIG. 1;

FIG. 3 is a schematic side view illustration of a motorcycle helmet for use with the safety system of FIGS. 1-2;

FIG. 4 is a schematic illustration of the motorcycle helmet of FIG. 3 with a display screen for use with the safety system of FIGS. 1-2; and

FIG. 5 is a schematic illustration of a method of using the safety system for the motorcycle of FIGS. 1 and 2.

### DETAILED DESCRIPTION

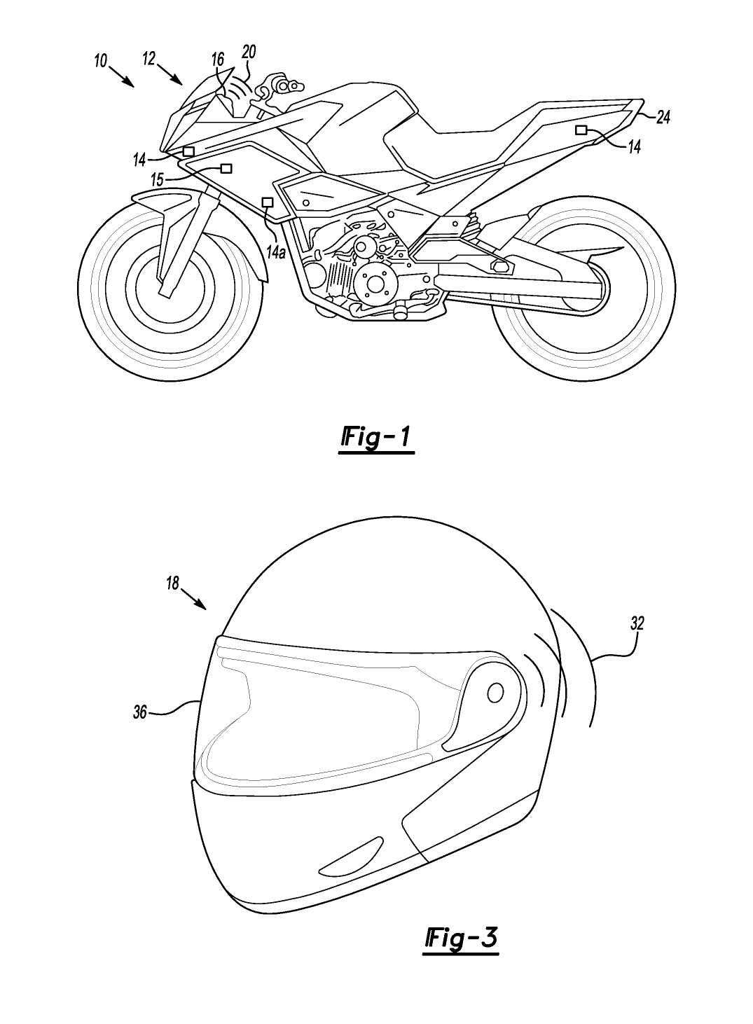

The following description is merely exemplary in nature and is in no way intended to limit the disclosure, its application, or uses. For purposes of clarity, the same reference numbers will be used in the drawings to identify similar elements. FIG. 1 illustrates a motorcycle 10 having a safety system 12 to provide increased safety awareness and warnings to an operator of the motorcycle 10. The safety system 12 as includes sensors 14 such as intelligent camera, radar, and/or lidar sensors. The sensors 14 can be used together, i.e. ‘sensor fusion’.

A display unit 16 such as a head unit/attachment for a helmet 18 may be used to provide warning indicators 20 to be able to visually warn the operator of the motorcycle 10 of the situation. Additional warning indicators 20 may be through a haptic warning, a warning sound and/or voice prompts as well. The warning indicators 20 may alternatively be displayed or produced by a display unit 16 mounted in close proximity of the handle bars and/or mirrors of the motorcycle 10 or by various indicator signals already located on the motorcycle 10. In addition, backward looking lighting 24 can be added to attract the attention and/or warn the driver of a vehicle 30 that is following the motorcycle 10, such as using the rear turn signal lights 24. The warning indicators 20 may also be displayed on or produced by already existing motorcycle 10 hardware, e.g. on the mirrors.

The safety system 12 can be used in conjunction with braking systems to apply the brakes 22 or pre-charge the brakes 22 for the motorcycle 10 to avoid crash scenarios. This can be done by having the sensors 14 mounted on the motorcycle 10 and provide driver assistance features such as blind spot detection, forward collision alert, rear collision alert, cross-traffic alert, merging-traffic alert, lane departure warning, traffic sign recognition, etc. In some instances, once the motorcycle 10 operator is notified of the intended information, the safety system 12 may also apply brakes 22 for the motorcycle 10.

The safety system 12 may increase driver awareness of the surroundings for safety and prevention of accidents. This safety system 12 addresses the huge impact of motorcycle accidents worldwide. The safety system 12 can help to reduce accidents, such as scenarios where: the motorcycle 10 is hit from behind by another vehicle; the motorcycle 10 moves into the path of another vehicle because of blind spots; another vehicle moves into the path of the motorcycle 10 while merging or crossing the path of the motorcycle 10; or an operator of the motorcycle 10 did not see the traffic speed sign and is, thus, unaware of the regulation in that area.

The safety system 12 can provide the operator of the motorcycle 10 assistance by providing blind spot detection, forward collision alert, rear collision alert, cross-traffic alert, merging-traffic alert, lane departure warning, traffic sign recognition and other operator assistance features. The safety system 12 uses sensors 14 mounted on the motorcycle 10 to detect scenarios that could be hazardous to the motorcycle's riders and then warn both the operator of the motorcycle 10 and/or the driver of the nearby vehicle 30 which is involved in the mentioned hazardous scenario. The sensors 14 can be one or more including but not limited to proximity sensors, radar sensors, lidar sensors and cameras.

Using the sensors 14 mounted on the motorcycle 10 at least one object/feature 30 of an environment surrounding the motorcycle 10 may be sensed and provided to an electronic control unit (ECU) 15 for the safety system 12, i.e. lane markers can be used to provide lane departure warnings, a following vehicle speed may be detected to provide rear collision alert, etc. The ECU 15 can compare the at least one feature to predefined thresholds 26 to determine if the feature is within a range that the operator of the motorcycle 10 should be alerted to increase safety awareness. For example, if the operator of the motorcycle 10 should be warned on an oncoming collision, or a change in traffic speed, or an object in the blind spot that is detected by the sensors 14. The electronic control unit 15 may be connected to at least one additional system on the motorcycle 10, such as the brakes 22 to instruct the motorcycle 10 to alter is operating parameters. If the ECU 15 determines that the object/feature 30 is within a range that the motorcycle 10 operator or another person in the area should be alerted to increase safety awareness an indicator 20 is sent that can be viewed by the motorcycle 10 operator and/or by a person proximate to the motorcycle 10, such as in another vehicle 30.

The at least one sensor 14 may include a long and/or short range radar unit, and/or a lidar sensor and/or a camera mounted on the motorcycle 10 that can be used to detect a possible crash from the rear of the motorcycle 10. The sensors 14, e.g. the radar unit can constantly calculate whether a vehicle that is driving behind the motorcycle 10 has enough time to slow down so as to not hit the motorcycle 10. The driver can then be made aware of the situation with enough time to take evasive action. This is especially important when the motorcycle 10 is at a standstill at traffic lights. In this situation any drivers following the motorcycle 10 may confuse the motorcycle 10 with the brake lights of a preceding car. By using the sensors 14 to calculate whether a possible crash is to occur the motorcycle 10 driver may be alerted to take preventative measures, the motorcycle 10 can take pre-crash precautions, such as pre-charging the brakes 22. Also, an external warning indicator 31 can be sent to the driver of the following vehicle, such as by flashing the rear turn signal/hazard lights 24 to gain the attention of the following driver and assist in distinguishing the motorcycle 10 from the surrounding environment.

The safety system 12 can also provide the external warning indicator 31 to the driver of the following vehicle 30 by means of flashing lights 24 mounted at the rear of the motorcycle 10. This type of warning may also be useful when the safety system 12 detects that another vehicle 10 is following the motorcycle 10 at a closer distance than safety recommends at those speeds.

The display interface 16 to warn the operator of the motorcycle 10 of a situation can be either mounted in the helmet 18 or on the motorcycle 10, e.g. close to the handlebars, such as on the rear view mirrors or be an existing indicator on the motorcycle 10. Radar can be also used to increase operator awareness of the motorcycle 10 regarding vehicles 30 which are in the blind spots of the motorcycle 10. An accelerometer or tilt sensor 14a is used for tilt adjustment of the sensors 14 while the motorcycle 10 is in a leaning, for example when going around a corner.

Additionally, driver training can be incorporated into the safety system 12. Part of the effectiveness of such a system 12 depends on the ability of the motorcycle operators to react quickly. Following the same recommendation that motorcycle operators practice braking and swerving at least once a year, the proposed safety system 12 can be placed into practice or training mode. Consider the scenario when a motorcycle 10 is stopped at traffic lights and the system 12 detects a possible collision from the rear. In practice mode (not on a public road), the proposed safety system 12 can simulate that it detects an impending collision and therefore alerts the driver with the proper warning indicator 20. The driver can then practice taking evasive action. Different scenarios can be chosen through the ECU 16 or a smart phone connected to the safety system 12. The scenarios may be randomly selected or programmed, such as by a course instructor.

Traffic sign recognition can be implemented with the motorcycle 10, as well, using the safety system 12. A sensor combination 14, most likely including at least one camera, will notify the motorcycle operator of traffic regulations in the area, current traffic speed, and can possibly also brake the motorcycle 10 accordingly. The appropriate vehicle level integration is needed that incorporates the safety system 12 to brake the motorcycle 10 to meet ISO and customer requirements.

The safety system 12 for the motorcycle 10 comprises the at least one sensor 14 mounted to the motorcycle 10 to sense at least one feature 30 of the environment surrounding the motorcycle 10. The electronic control unit 15 is connectable to at least one system 32 for the motorcycle 10. The electronic control unit 15 is configured to receive a signal from the at least one sensor 14 with the at least one feature 30. The ECU 15 determines with an electronic control unit for the safety system a probability that a safety incident may occur based upon the at least one feature and compares the probability to at least a first threshold 26. The electronic control unit 15 is configured to send at least one indicator signal 20 when the at least one feature is within the first threshold 26 for safety awareness. For example, if the system 12 detects an object 30 in a blind spot area 28 for the operator of the motorcycle 10 an indicator signal 20 can be displayed on a mirror on the corresponding side of the motorcycle 10. There may be multiple thresholds for safety awareness which may have several alert levels. Using the example above, when an object 30 is detected by the blind spot system an indicator signal 20 is displayed. However, the operator of the motorcycle 10 activates a turn signal a second threshold 27 may be exceeded due to increased safety concern. A second indicator signal 32 may be sent to the motorcycle 10 operator. The light on the mirror may flash and/or a sound may be produced through a helmet 18 that is in communication with the ECU 15 for the motorcycle 10. The intensity of the alert may be increased as the distance between the detected object 30 and the motorcycle 10 decreases.

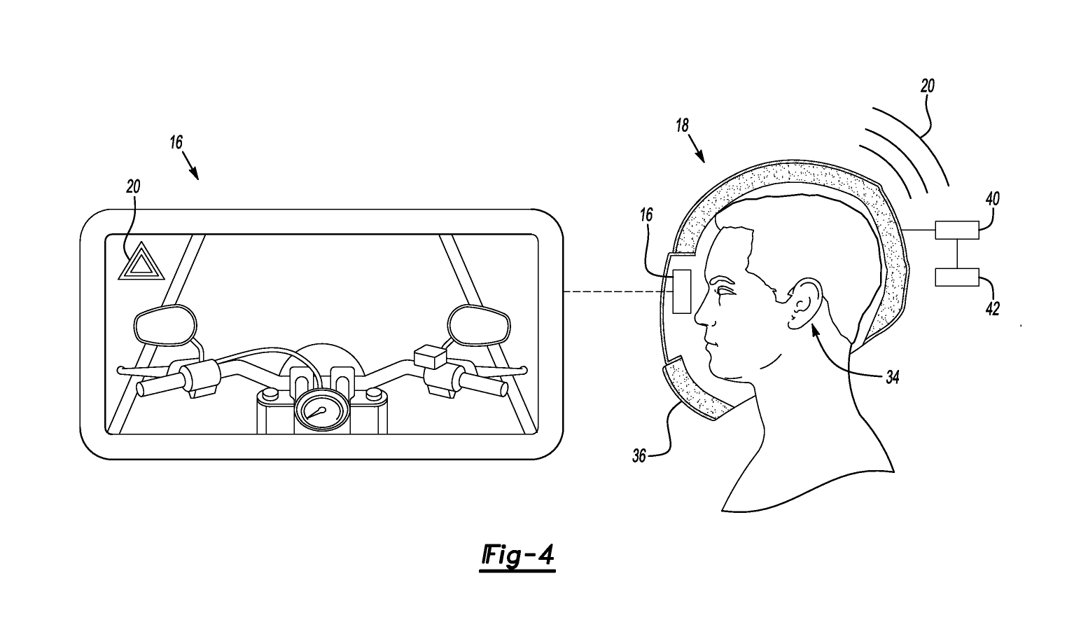

FIGS. 3 and 4 illustrate one embodiment of a helmet 18 for use with the motorcycle 10 and safety system 12 of FIG. 1. The helmet 18 may be linked to the ECU 15 for wireless communication with the safety system 12. The communication link between the ECU 15 and the helmet 18 may be any wireless communication link, e.g. Bluetooth, cellular link, etc. The helmet 18 may have built in speakers 34 to produce audio signal to the operator of the motorcycle 10. Additionally, the helmet 34 may include a visor 36 and a display screen 16. The display screen 16 may be incorporated into the visor 36 or may be a separate screen. Preferably display screen 16 is arranged to minimize obstruction of the operator's field of view. The display screen 16 may be transparent when and/or images are not displayed. The display screen 16 may also be positioned in a location that does not obstruct or minimizes obstruction of the operator's view of the road and surrounding environment. In FIG. 4 the display screen 16 is illustrated as a small screen on the upper right corner of the visor 36. There may be an additional screen located at the upper left corner of the visor 36 as well. Alternatively, the display screen 16 may be larger, but clear allowing the motorcycle operator to see through. Alerts may be shown on the display screen 16, but the remaining portion of the display screen 16 may remain clear minimizing obstruction of the operator's sight, as shown in FIG. 4.

The display screen 16 may be controlled by a helmet ECU 40 and powered by a helmet power source 42. The helmet ECU 40 and helmet power source 42 may be incorporated into the helmet 18 itself of may be separately located and attached to the helmet 18. For example, the helmet ECU 40 and helmet power source 42 may be in a pack that is located on the driver, such as in a coat pocket, a power cord may plug into a received within the helmet 18 to provide power to the helmet 18 for communication with the motorcycle 10, producing audio alert signals, and display of images on the display screen 16. Alternatively, one of the ECU 40 and helmet power source 42 may be incorporated into the helmet 18 and once may be separately located and connected through a remotely located wired connection. For wireless communication, an emitter may be located on the motorcycle 10 and may be included in the ECU 15 and a receiver may be incorporated on the helmet 18 separately or as part of the helmet ECU 15.

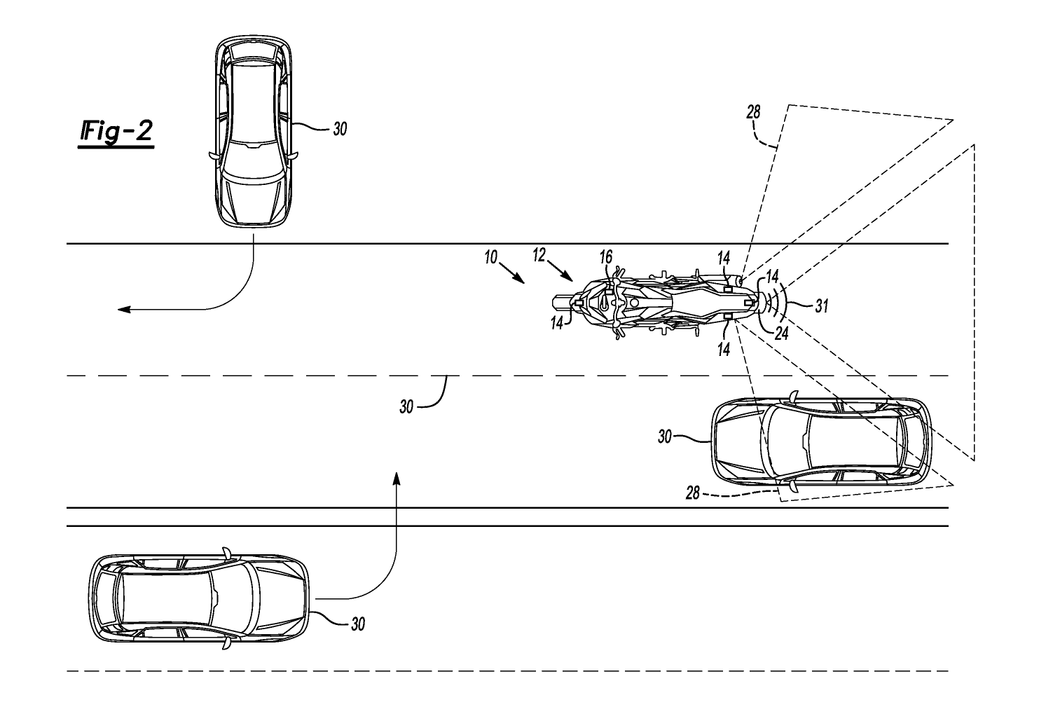

Referring back to FIGS. 1 and 2, some driving situations are more dangerous for motorcycle operators and the safety system 12 could be configured to alert the motorcycle operator in these situations as well as blind spot detection, forward collision alert, rear collision alert, lane departure warning, and traffic sign recognition. Two situations where alerting a motorcycle operator would be useful is cross traffic alerts and merging traffic alerts. The safety system 12 may provide detection of oncoming traffic that is making or intending a left turn that will cross the motorcycle 10 path, i.e. cross-traffic alert, and detection of traffic from cross-roads or driveways that will be turning into the path of the motorcycle 10, i.e. merging-traffic alert. In both of these situations the operator of the motorcycle 10 may have trouble detecting and/or anticipating the other traffic 30. A cross-traffic alert or a merging-traffic alert 20 would benefit the motorcycle 10 operator. In addition, the other vehicle 30 operators may not be aware of the motorcycle 10 presence. In both situations, the sensors 14 may detect the movement of the other traffic 30 and provide a warning indicator 20 to the motorcycle operator 10. This may also involve using other existing sensors on the motorcycle 10. For example, if oncoming traffic is about to make a left turn from a stop the safety system 12 may be able to detect forward motion of the other vehicle 30 prior to motorcycle 10 operator by using a speed sensor for the motorcycle 10 and comparing it to the relative speed of the oncoming traffic detected with forward looking sensors 14 such as lidar, radar, and/or a camera. Additional features that may be detected by the sensors 14 and used by the ECU 15 to detect an event may include detecting a turn signal on another vehicle, detecting speed of the other vehicle, detecting movement of the other vehicle that is lateral to the motorcycle movement, etc. The safety system 12 would provide an alert 20 to the motorcycle operator allowing the motorcycle operator to move or brake if necessary to avoid collision when the vehicle 30 operator is unaware of the motorcycle 10 presence. In addition to alerting the motorcycle 10 operator in these and other situations the safety system 12 may be able to communicate and provide an external alert 31 to the other vehicles 30 providing a warning to operators of the presence of a motorcycle 10, such as by motorcycle 10 to vehicle 30 communication.

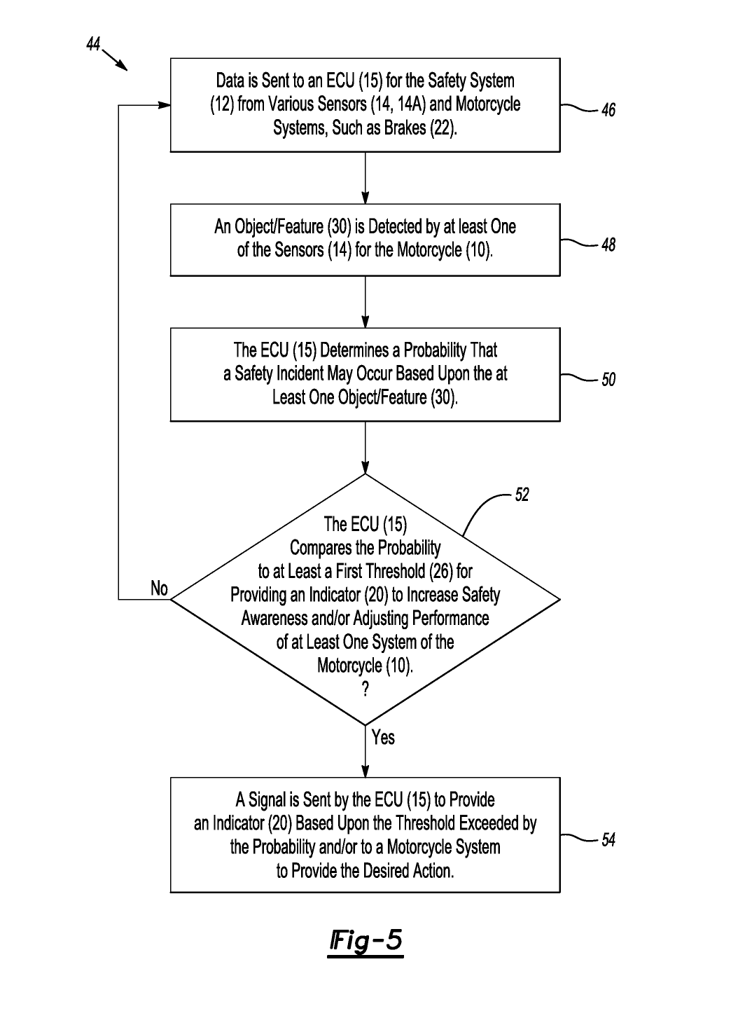

FIG. 5 illustrates one embodiment of a method, shown at 44, of improving safety for a motorcycle 10 comprises sensing, step 46, at least one feature 30 of an environment surrounding the motorcycle 10 with at least one sensor 14 mounted to the motorcycle 10. An object/feature 30 may be detected by the sensors 14, step 48. An electronic control unit 15 for the safety system 12 determines a probability that a safety incident may occur based upon the at least one feature, step 50. The ECU 15 compares the probability to at least a first threshold 26 for safety awareness, step 52. The electronic control unit 15 provides an indicator 20 that is capable of being sensed by at least one of an operator of the motorcycle 10, and/or an external indicator 31 that is capable of being sensed by a person in proximity to the motorcycle 10 when the at least one feature is above the first threshold 26 for safety awareness, step 52. The severity of the indicator provided in step 52 corresponds to the threshold the probability has exceeded.

The method 44 of providing an indication may include at least a visual warning on a head unit/helmet 18 that is linked to the motorcycle. In one example, the first threshold 26 is detection of an object 30 within a blind spot area 28 and the visual warning indicates the presence of the object 30 in the blind spot area 28 by displaying the alert 20 on a screen 16 located in the head unit/helmet 18.

The method 44 may also include adjusting an operating parameter of the motorcycle 10 when the at least one object/feature 30 meets the first threshold 26 for safety awareness. Indicators 20 may provide blind spot detection, forward collision alert, rear collision alert, cross-traffic alert, merging-traffic alert, lane departure warning, and traffic sign recognition.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of improving safety for a motorcycle comprising:
sensing at least one feature of an environment surrounding the motorcycle with at least one sensor mounted to the motorcycle, wherein sensing at least one feature includes sensing with one of a lidar, a radar, and a camera;
determining with an electronic control unit for the safety system a probability that a safety incident may occur based upon the at least one feature;
comparing the probability to at least a first threshold; and
providing an indicator that is capable of being sensed by at least one of an operator of the motorcycle, and a person in proximity to the motorcycle when the probability meets the at least first threshold.

2. The method of claim 1, wherein the indicator is at least one of an audio warning, a visual warning, and a haptic warning.

3. The method of claim 2, wherein providing the indicator further comprises increasing the severity of the indicator based upon the probability exceeding a second threshold.

4. The method of claim 3, wherein increasing the severity of the indicator further comprises increasing at least one of: the number of warnings, the frequency of the warning and the intensity of the warnings.

5. The method of claim 1, wherein providing an indicator further comprises at least a visual warning on a head unit that is linked to the motorcycle.

6. The method of claim 1, wherein the first threshold is detection of an object within a blind spot area, wherein the indicator is a visual warning displayed on a screen supported the head unit to indicate the presence of the object in the blind spot area.

7. The method of claim 1, further comprising adjusting an operating parameter of the motorcycle when the at least one feature meets the first threshold for safety awareness.

8. The method of claim 1, wherein providing the indicator further comprises providing one of blind spot detection, forward collision alert, rear collision alert, cross-traffic alert, merging-traffic alert, lane departure warning, and traffic sign recognition.

9. The method of claim 1, wherein sensing at least one feature includes sensing with one of a lidar, a radar, and a camera.

10. A safety system for motorcycle comprising:
at least one sensor mounted to the motorcycle to sense at least one feature of an environment surrounding the vehicle, wherein the at least one sensor is one of a radar, a lidar and a camera;
an electronic control unit connectable for the safety system, wherein the electronic control unit is configured to receive a signal from the at least one sensor, to determine a probability that a safety incident may occur based upon the at least one feature, and to compare the probability to at least a first threshold; and
wherein the electronic control unit is configured to send at least one indicator signal when the at least one feature is above the at least first threshold for safety awareness.

11. The safety system of claim 10, further comprising a head unit in electronic communication with the electronic control unit, and wherein the at least one indicator signal is sent to the head unit.

12. The safety system of claim 10, wherein the safety system is one of blind spot detection, forward collision alert, rear collision alert, cross-traffic alert, merging-traffic alert, lane departure warning, and traffic sign recognition.

13. A method of improving safety for a motorcycle comprising:
sensing at least one of a feature of a vehicle proximate to the motorcycle with at least one sensor mounted to the motorcycle;
determining with an electronic control unit for the safety system a probability that the vehicle is preparing to perform one of crossing the path of the motorcycle and moving into the path of the motorcycle;
comparing the probability to a threshold; and
providing an indicator that is capable of being sensed by at least one of an operator of the motorcycle and a person in proximity to the motorcycle when the probability is greater than the threshold.

14. The method of claim 13, wherein providing an indicator further comprises at least one of: communicating a signal to a helmet to provide a visual indicator, flashing the motorcycle headlight, wirelessly communicating a message to the other vehicle from the motorcycle.

15. The method of claim 13, further comprising adjusting an operating parameter of the motorcycle when the probability is above the first threshold for safety awareness.

16. The method of claim 13, wherein sensing at least one feature includes sensing with one of a lidar, a radar, and a camera.
